(19) United States
(12) Patent Application Publication
(10) Pub. No.: US 2026/0251878 A1
(43) Pub. Date: Aug. 27, 2026

(54) POSITIONING DEVICE FOR CABLES FOR CARRYING OPTICAL/ELECTRICAL SIGNALS, METHOD AND ASSOCIATED KIT

(71) Applicant: OUT LINE S.R.L., Roma (RM) (IT)

(72) Inventor: Marco BORGHI, Roma (RM) (IT)

(21) Appl. No.: 19/162,125

(22) PCT Filed: Mar. 1, 2024
(86) PCT No.: PCT/IB2024/051995

§ 371 Date: Sep. 4, 2025

(30) Foreign Application Priority Data
Mar. 6, 2023 (IT) 102023000003984

(51) Int. Cl. G02B 6/44; H02G 3/30

(52) U.S. Cl. CPC G02B 6/4459; H02G 3/305

(57) ABSTRACT

A positioning device (1) for cables has a main body (1a) having an internal cavity (2) in which it is possible to removably house at least one optical or electrical cable when the positioning device (1) is positioned on a building material. A first bottom surface (3) delimits the main body (1a) on the lower part and is reversibly fixable to the building material. Second and third surfaces (5) opposite the bottom surface (3) with respect to the cavity (2) delimit the main body (1a) on the upper part. The second and third surfaces (5) have an area with a tapered section and corresponding edges (6) arranged in contact in a rest position of the device and movable or deformable so as to be separable in use when an optical or electrical cable is inserted in the cavity.

### FIELD OF THE ART

The present invention refers to a positioning device for cables capable of transporting optical or electrical signals in the internal settings of a building. The present invention also refers to an installation kit comprising at least a positioning device. The present invention, in addition, claims a kit for positioning cables capable of transporting optical or electrical signals, comprising said device.

### STATE OF THE ART

The transmission of signals within buildings is of such great importance that it is increasingly frequent to have the need to carry out wiring operations within a building, which can require a thorough series of interventions analogous to the attainment of a hydraulic plant. Even if in specific moments, these operations may be easy to achieve, such as for example during construction or restructuring of the building, often however it is necessary to resolve other problems due to structural constraints, create alternative solutions or entirely or partly give up in the attainment thereof.

There are for example the problems tied to the increasing diffusion of the services offered by means of broadband, from which there is an increase of the need to be able to process great quantities of data at high speed in office and in private homes. This involves the progressive abandonment of copper cables in favor of optical cables, since the latter allow a data transmission at a greater distance and with a higher transmission speed, in addition sustaining less signal attenuation along the transmission path. However, the installation of optical fiber cable is more complex and more expensive than the wiring carried out with copper cables, in addition to the fact that the optical fiber cable is much more fragile and therefore more easily subject to breakage with respect to copper cable.

The optical fiber cables which transport the optical signals within a house, an apartment, an office or other places generally have origin starting from a termination point within the immobile that usually appears as a small box, also known as socket. The technicians abut the fiber cable coming from the building termination point or from a building optical splitter on the socket. In the rooms for office use or residential use of a building, the cables are preferably distributed within the building, usually through the use of small channels or set in ducts that run within the walls. However, for specific types of buildings, and in particular the oldest ones, this implementation type can be decidedly time-consuming and expensive, or even impractical.

Several patents have already confronted the subject of wiring of fiber optic networks. One example is the document JP8327857A, which describes a multiple optical fiber cable and an installation method that has as advantage the reduction of size and weight of the branched portion. Another example is the document BRPI1005554A2 which describes a terminal board for fiber optic networks in which the box is provided with dividing parts provided with compartments that are independently accessibly from a cover. The design of the box reduces the risk of potential damage to the optical fibers in a simple manner. The box is easy to maintain and practical to use, and provided with greater ease of use. The box can identify the optical fibers in a simple manner and the defect/damage caused by installation can be reduced. Even if the box is high quality and easy to use, it is clear that this document, like that previously described, and generally the prior art, are unable to provide a kit adapted for the quick and reversible installation of a fiber optic network within a building.

### OBJECTS AND SUMMARY OF THE INVENTION

The object of the present invention is to present a positioning and fixing device for cables for carrying optical or electrical signals such to facilitate the operations of installation thereof in the internal settings of a building with a solution that is also economically advantageous so as to at least partly overcome the underlined problems of the prior art.

The object of the present invention is achieved by a positioning device comprising:
a main body having an internal cavity in which it is possible to house, in a removable manner, at least an optical or electrical cable when said positioning device is positioned on a building material;
a first bottom surface, delimiting the main body on the lower part, and reversibly fixable to the building material;
a second and a third surface opposite the bottom surface with respect to the cavity and delimiting the main body on the upper part; said second and third surfaces having an area with a tapered section and corresponding edges arranged in contact in a rest position of the device and movable or deformable in a manner such to be separable during use when an optical or electrical cable is inserted in said cavity.

The positioning device is easy and reversibly installable since it can be fixed to the building material present within a building, reducing and simplifying the interventions during the wiring of the rooms of a building. By building material, materials are intended which can be but are not limited to: wood, plaster, bricks, plasterboard, concrete, steel, etc. with which it is possible to make walls, floors, ceilings and any other load-bearing or dividing structure within a building. By building it is intended one or more rooms arranged vertically and/or horizontally, adjacent to each other and equipped for home use, office use, commercial use etc.

Preferably the positioning device is fixed to the building material by means of an adhesive strip applied on the bottom surface.

Preferably the positioning device is made of transparent or translucent material in order to facilitate the display of the cable at its interior, and hence the verification of its integrity.

According to a preferred embodiment the positioning device is sized such to be able to house a plurality of cables at its interior.

According to a further embodiment the positioning device is only applied in some sections of the cable with the purpose of ensuring the positioning thereof, especially in points of particular importance such as in proximity to curves, corners or edges.

In this manner, the positioning device is adapted to house the cable without interfering with its performances or obstructing possible visual inspections and simultaneously reducing the visual impact in the rooms where it is installed.

According to a further preferred embodiment, the positioning device can be part of a kit for positioning optical cables in the internal settings of a building. The positioning kit, for example for the wiring of the fiber within a building, can comprise one or more of said positioning devices, a flat frame box for optical fiber adapted to receive the entering optical cable and to branch it out at the exit, a cover for said flat frame box, one or more curved elements to allow the wiring of the different settings, even in the presence of obstacles such as corners or edges on the walls, one or more wall plugs with relative cover for guiding the insertion of the optical cable through a wall. In this manner, the kit allows reducing the bulk of the elements used during wiring and consequently reducing the visual impact upon completed wiring.

Other advantages of the present invention are discussed in the description and mentioned in the dependent claims.

### BRIEF DESCRIPTION OF THE DRAWINGS

The invention is described hereinbelow based on non-limiting examples, illustrated as an example in the following figures, which respectively refer to:

FIG. 1 is a sectional view of the positioning device;

FIG. 2 is a perspective view of the device shown in FIG. 1;

FIG. 3 is a perspective view of a flat frame box for optical cable and the relative cover;

FIG. 4 shows a detail of the flat frame box of FIG. 3 in which the elements are shown which allow dispersing the extension of the entering optical cable;

FIG. 5a shows a perspective view of a wall plug for the passage of a cable capable of transporting optical or electrical signals from one room to an adjoining one and the relative cover,

FIG. 5b shows a sectional view of a wall through which a cable passes by means of the use of wall plugs and with the addition of a protection tube for the passage within the wall;

FIG. 5c shows the wall plug used as junction box;

FIGS. 6a, 6b, 6c show perspective views of possible embodiments of an element for curved or angular surfaces;

FIG. 7 shows an aid instrument for inserting an optical cable within the positioning device;

FIG. 8 shows a first example of wiring by means of the kit of the present invention;

FIG. 9 shows a second example of wiring by means of the kit of the present invention;

FIG. 10 shows an example of repair of an optical cable hidden by the positioning device.

### DETAILED DESCRIPTION OF THE INVENTION

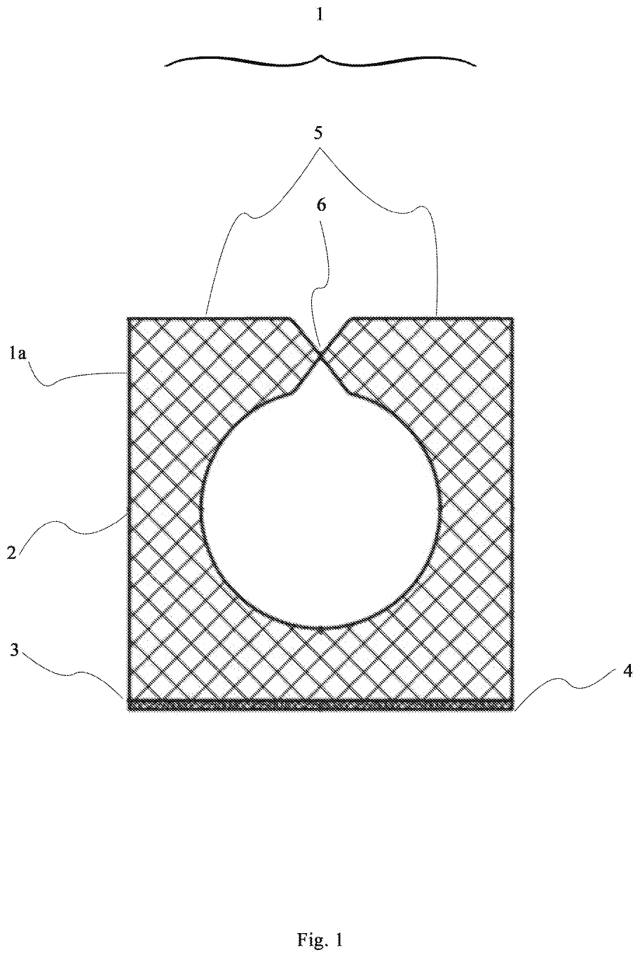

FIG. 1 shows a sectional view of the positioning device 1 for cables capable of transporting optical or electrical signals. Hereinbelow, described merely by way of example, is an embodiment referred to its use with optical cables, but the invention is not intended to be limited only to this form. The main body 1a of the positioning device 1 has an internal cavity 2 capable of removably housing one or more optical cables.

The main body 1a is on the lower part delimited by a bottom surface 3 which allows fixing the positioning device 1 to the building material present in a building. By building material, materials are intended such as for example: wood, plaster, bricks, plasterboard, concrete, steel, etc. with which it is possible to make walls, floors, ceilings and any other load-bearing structure or other structure inside a building. By building it is intended the one or more adjoining rooms arranged vertically and/or horizontally, equipped for residential use, office use, commercial use etc.

Preferably the bottom surface 3 has an adhesive material layer or a double-sided tape 4 due to which the action of fixing the positioning device 1 on the building material occurs in a simple manner, when the device is placed in contact with the surface to which it is intended to be fixed, due to only the application of a suitable pressure that allows the device to remain attached to the selected surface. It is therefore evident that the proposed solution is easy to apply within the internal settings of a building where one intends to carry out the wiring with the fiber.

A second and third upper surface 5, opposite the bottom surface 3 with respect to the cavity 2, delimit the main body 1a on the upper part. Said second and third upper surfaces 5 have an area with a tapered section and corresponding movable and deformable edges are arranged in mutual contact in a rest position, said edges respectively defining two flaps 6 in contact with each other.

The presence of the flaps 6 on the upper surface 5 of the positioning device 1 allows easily inserting the optical cable within the cavity 2 of the device. Indeed, the action of inserting the optical cable involves the simultaneous separation of the flaps 6 which facilitate the passage of the optical cable, at the end of which said flaps 6 return to their initial mutual contact position, preventing the exit of the optical cable. This is particularly advantageous when the wiring is carried out vertically on vertical surfaces or on the ceilings of a building. Further advantage of this configuration is that, when the optical cable is within the positioning device, this is completely wound, protecting it from dust, moisture and increasing protection against possible accidental impact that could damage it.

The positioning device 1 is preferably made of silicon material having elastic properties such to allow a degree of flexibility thereto such that it can take on angular configurations that are compatible with the radius of curvature allowed for an optical cable, without this sustaining damage or without excessive curvature causing signal weakening. A possible radius of curvature interval for the optical cables usable with the present invention is between 5 mm and 7.5 mm. The positioning device can be shaped in order to house different types of cables with different diameters, e.g. optical monomodal cables, optical multimodal cables, copper cables etc. In addition, the positioning device can be shaped in order to be able to house at its interior a plurality of cables of the same type. For example, the suitably sized positioning device can house four optical cables simultaneously.

The positioning device 1 of the present invention goes beyond many of the limits that can be encountered in the operations of wiring a building, such as for example the presence of columns, edges, lack of service interspaces etc., that often require costly building works as the only alternative.

Preferably the positioning device 1 is made of colorless, non-opaque material such to allow the visual inspection of the optical cable at its interior. In this manner, the use of the suitable instruments will be facilitated, or at least not obstructed, in order to find the failure points. Alternatively, the positioning device can be made of a colored silicon material and/or can be painted so as to further decrease its visibility within the settings.

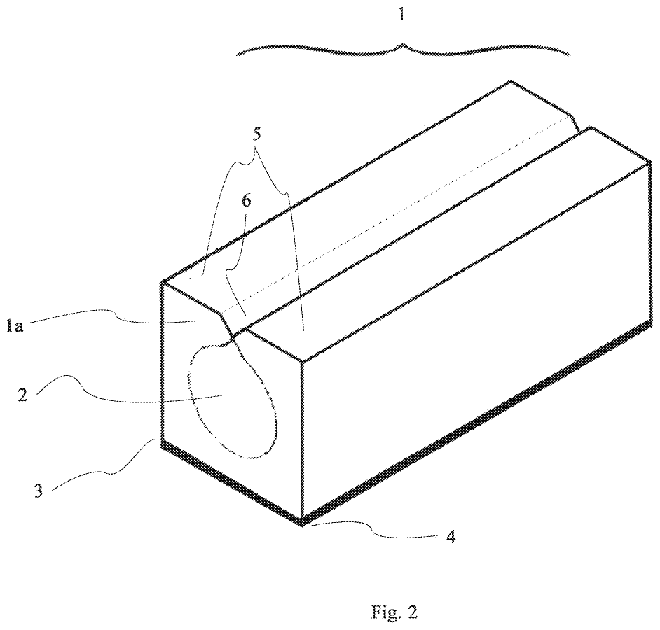

FIG. 2 shows a perspective view of the positioning device 1, from which the cavity 2 is particularly evident which is capable of housing the cable, and a possible embodiment is seen of the flaps 6 present in the upper surface 5 which are positioned in an equidistant manner between the internal cavity 2 and the upper surface 5. For the man skilled in the art, it is obvious to obtain different configurations of the positioning device 1, where the point of contact between the two flaps 6 is not a median point between the cavity 2 and the upper surface 5 without departing from the idea underlying the invention.

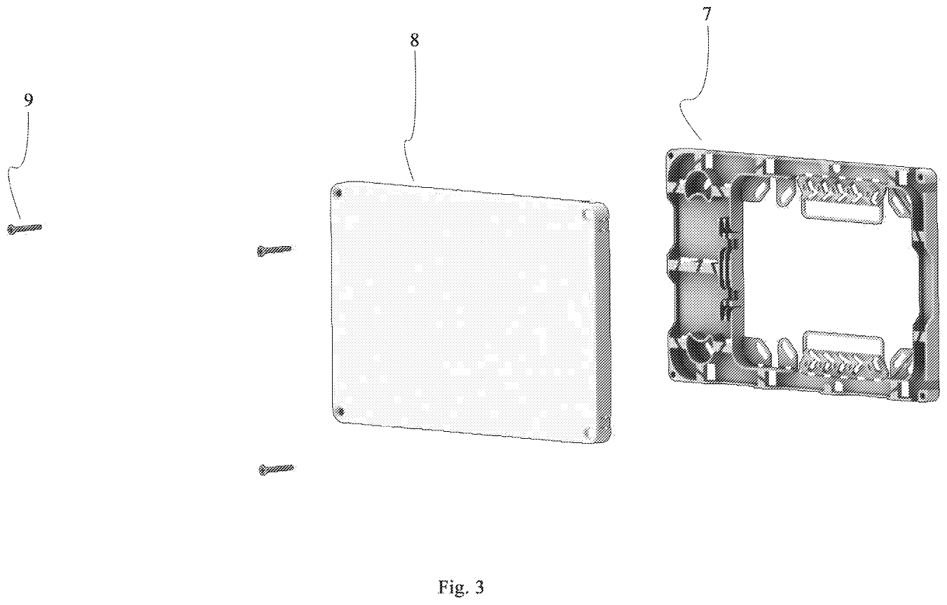

FIG. 3 shows several elements necessary for the wiring of a building, in particular the figure shows the flat frame box 7 and the relative box cover 8 and the relative hardware fixtures 9 for the fixing. The flat frame box 7 is by shape and size comparable to a common junction box, therefore minimizing the visual impact once installed.

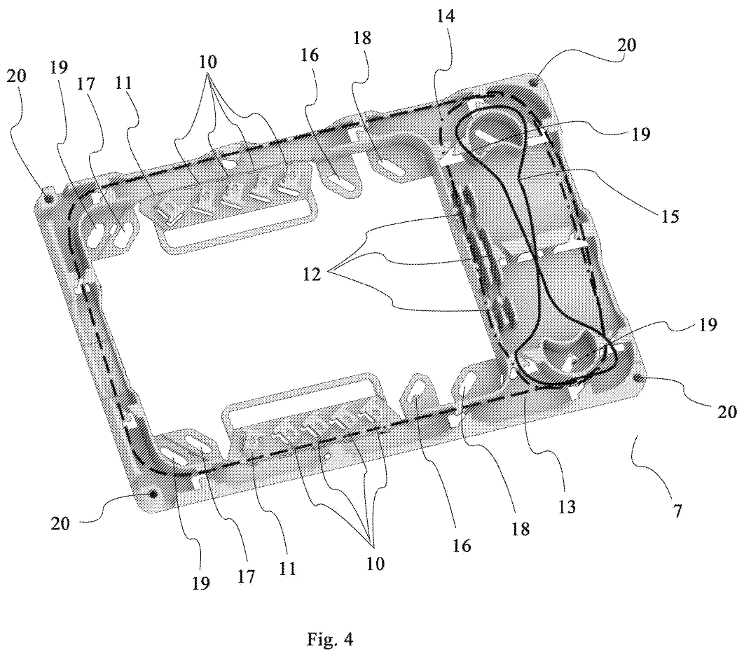

As is visible with greater detail in FIG. 4, the flat frame box 7 facilitates the operations of joining and termination during the installation step. In particular, the flat frame box 7 is provided with outputs 10 for fibers of single-fiber type with 2.6 mm diameter, with inputs 11 for fibers of bundle type with 3 and 4 mm diameter, in addition to a plurality of heat-shrinking joint-cover positions 12.

In addition, the flat frame box 7 provides for specific elements in order to manage the possible extension of the optical cable. In particular, the flat frame box 7 provides for a first type of dispersion of greater extension with wide passage, indicated in the figure with a dashed line 13, and a dispersion with narrow passage indicated in the figure with a dash-point line 14 with the possibility of exploiting a possible intersection element indicated in the figure with a solid line 15.

The flat frame box 7 also provides for a series of slots in order to facilitate the fixing on junction boxes of different types. The figure shows a first series of slots 17, 16 in order to be adapted to the junction boxes of type PT1, a second series of slots 17, 18 in order to be adapted to the junction boxes of type PT2 and PT3 and a third series of slots 19 in order to be adapted to junction boxes of type PT4.

Finally, the flat frame box 7 is provided with holes 20 in order to allow the fixing of the box cover 8 once installation operations have terminated.

The flat frame box 7 can for example be used for wiring a floor of a building in which it is typically positioned on the land the apartment/apartments to be wired are situated. The cables depart from the flat frame box 7 in order to enter within the single apartments.

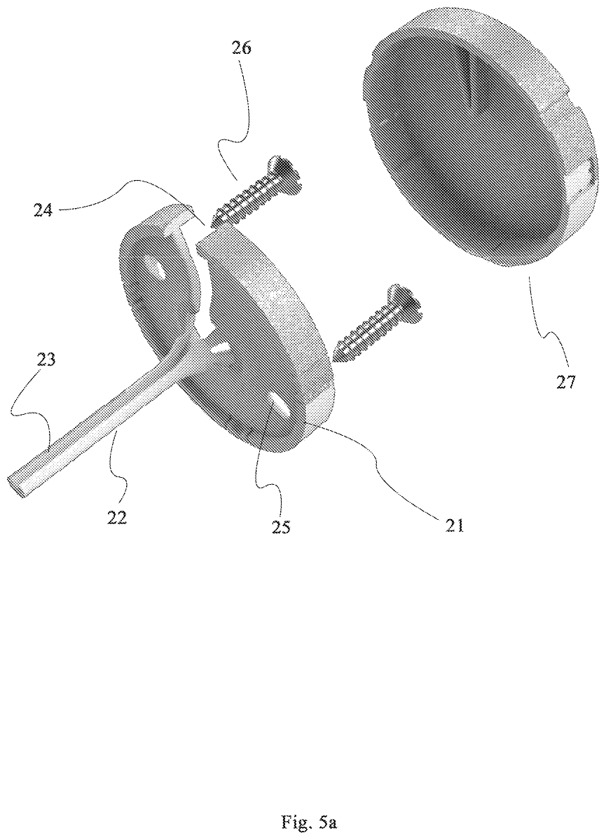

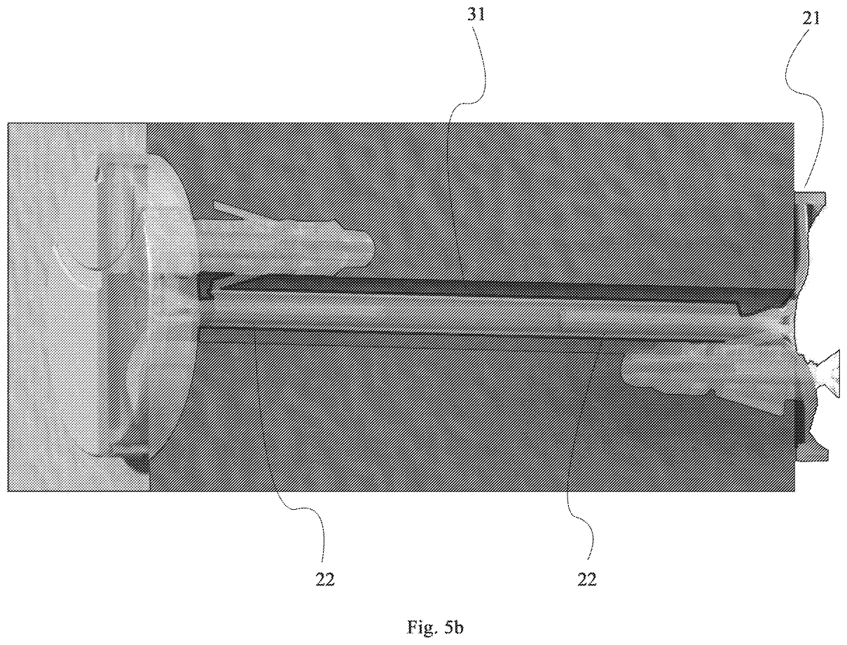

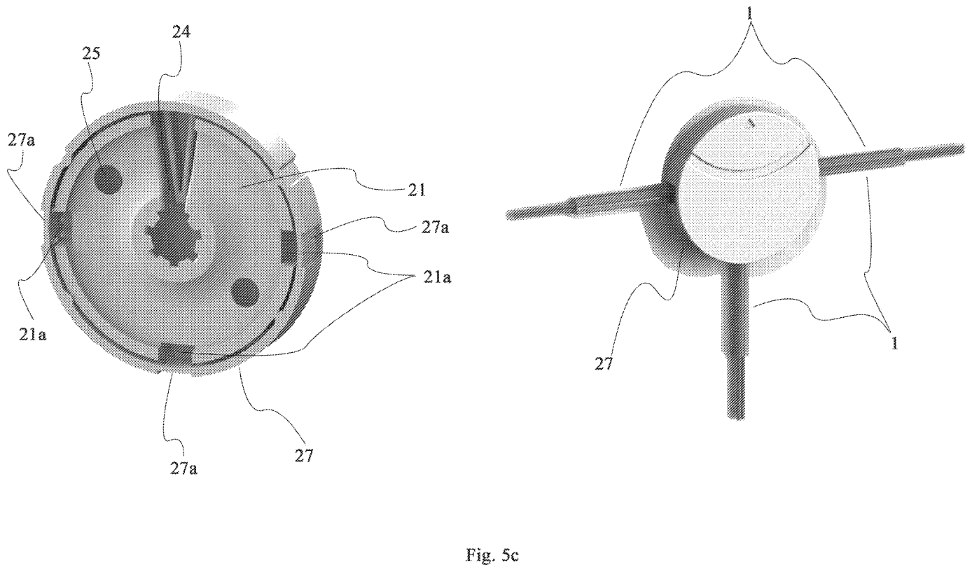

FIG. 5a is a perspective view of a wall plug 21 which allows the passage of an optical cable through a hole created in a wall.

In particular, the figure shows a plug 21 with circular shape, from whose center a nozzle 22 is projected, on which a groove 23 is present that acts to introduce the optical cable when inserted within the wall. An opening 24 is present between the external edge and the center of the plug 21 from which the nozzle 22 is extended. The presence of the groove 23 and of the opening 24 allow easily inserting an optical cable within the plug 21 before this is positioned within the wall. The plug finally has holes 25 for the wall fixing.

Still in the figure, the hardware fixtures 26 are visible for the wall fixing and the cover 27 of the plug which, in a manner analogous to that stated for the flat frame box 7, due to its limited size and its appearance, minimizes the visual impact of the plug 21 once fixed. Alternatively, the wall plug 21 can be fixed in position by means of the use of double-sided adhesive strips. For the man skilled in the art, it is obvious to obtain plugs with different geometries without departing from the idea underlying the invention.

FIG. 5b shows a sectional view of a wall through which an optical cable is passed through. In particular, it is possible to view how, also within a wall, the optical cable is always protected due to the nozzles 22 which respectively extend from the center of the two wall plugs 21 but above all due to a tubular element 31 which is extended from the first to the second wall plug 21, coming to cover the grooves 23 present on the nozzles 22.

In FIG. 5c, on the left, the wall plug 21 is instead shown which, lacking the nozzle 22, can be used as junction box. Indeed, along the perimeter, a plurality of grooves 21a are present which allow the outlet of multiple optical cables, for example allowing the branching of optical cables from a flat frame box 7 towards different apartments present on the floor. The cover 27 at the grooves 21a present on the wall plug 21 has zones of reduced thickness 27a such that they are easily removable with an instrument, such as for example a gripper, such to open the outlet for an optical cable when necessary. FIG. 5c, on the right, shows the wall plug 21 used as junction box from which three optical cables exit, each suitable covered by the positioning device 1 according to the present invention.

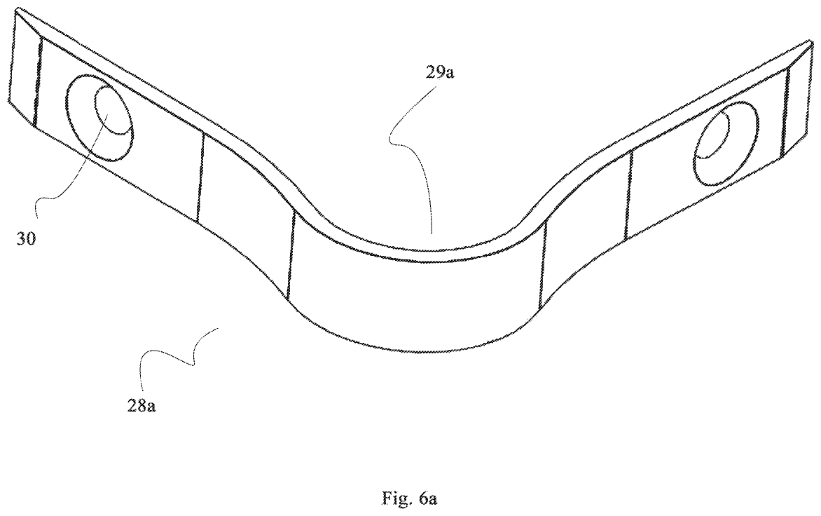

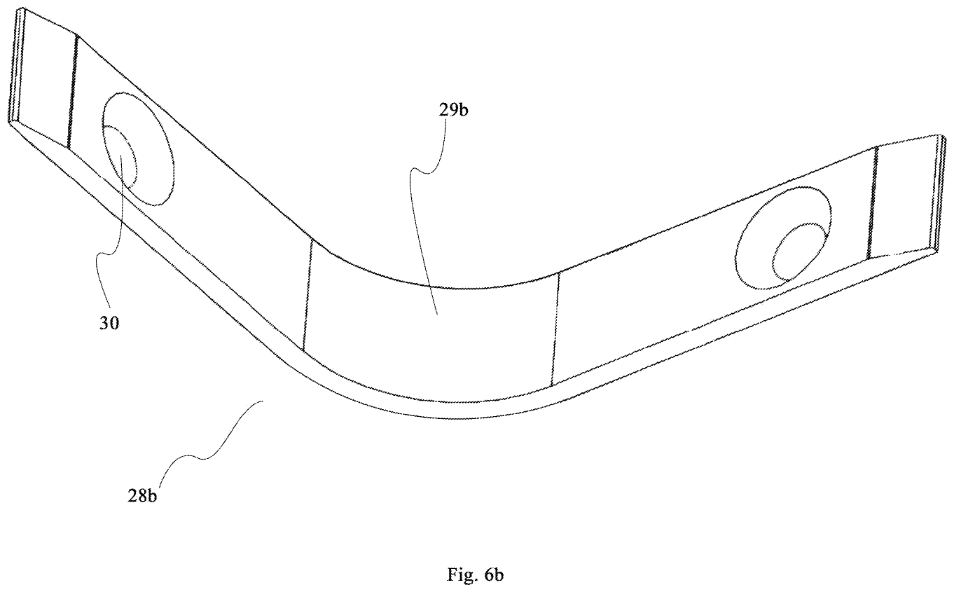

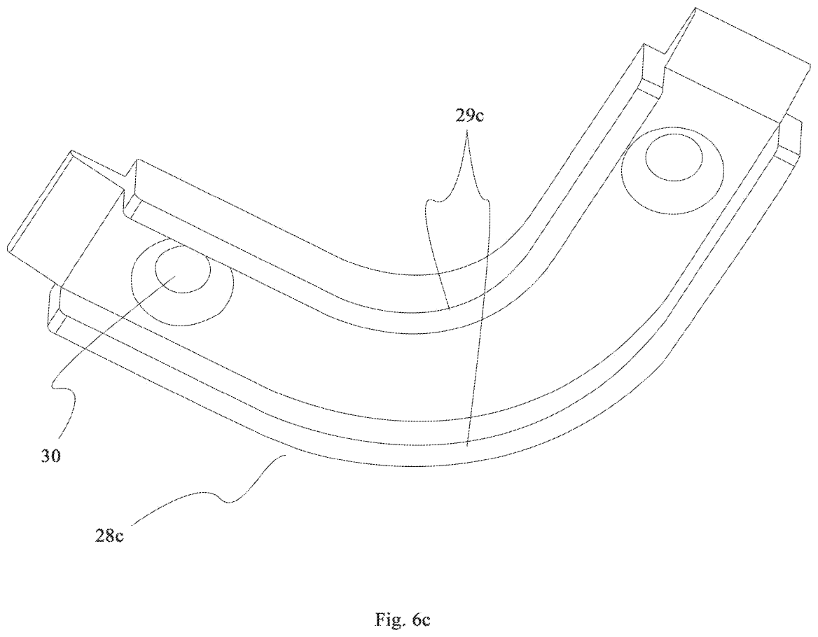

FIG. 6a shows a first embodiment of a curved element 28a which allows setting the optical cables in the internal settings also in the presence of obstacles such as corners, edges, columns, etc.

In particular, the form of the section 29a which is placed in contact with an edge of the obstacle has a radius of curvature compatible with the radius of curvature allowed for an optical cable applied thereon, without the latter sustaining any type of damage or which increases the signal attenuation.

A possible interval of radius of curvature for the optical cables usable with the present invention is between 5 mm and 7.5 mm.

Also shown in the figure are holes 30 which allow fixing the curved element on the obstacle. FIG. 6b shows a second embodiment of a curved element 28b which allows setting the optical cables in the internal settings, also in the presence of obstacles such as cavities, recesses and concavities present in the walls. Analogous to that described above, also in this case the form of the section 29b which is placed in contact with the obstacle has a radius of curvature allowed for being compatible with the radius of curvature allowed for an optical cable applied thereon. Also in this form, holes 30 are present for fixing the curved element 28b.

FIG. 6c shows a third embodiment of a curved element 28c which allows bending an optical cable along a wall according to a radius of curvature compatible with the radius of curvature allowed for an optical cable. In particular, this embodiment has a pair of projections 29c along the edges on which the optical cable is set. As for the preceding embodiments, also here holes 30 are present which allow the fixing thereof on a wall.

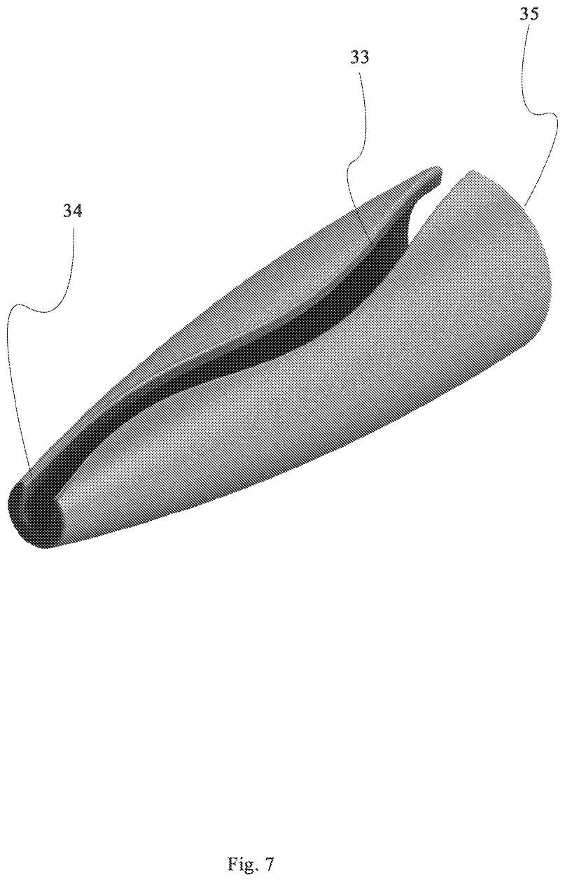

FIG. 7 shows an instrument used during installation that allows easily inserting an optical cable within the positioning device and/or positioning it on, or within, one or more of the other elements described above, preventing directly touching the optical cable. In particular, the conical shape allows an easy and firm grip by a user. Said instrument having a hollow body and two openings 34, 35 positioned on two opposite ends according to a longitudinal direction and a groove 33 between the first opening 34 and the second opening 35 such that a cable is easily inserted through the groove 33 and the sliding action of the cable, along the instrument, between the two openings allows the positioning within the positioning device 1 or one of the other elements described, preventing direct manipulations of the cable.

The elements described up to now can be part of a kit for fixing the object to be simplified, in terms of time, the wiring operations for the internal rooms of a building, reducing the necessary building works. It is evident that this consequently involves a smaller wiring cost.

The kit, depending on the requested wiring needs, can comprise all the described elements or a subset thereof in order to reply, in the most appropriate way possible, to the needs of the different users.

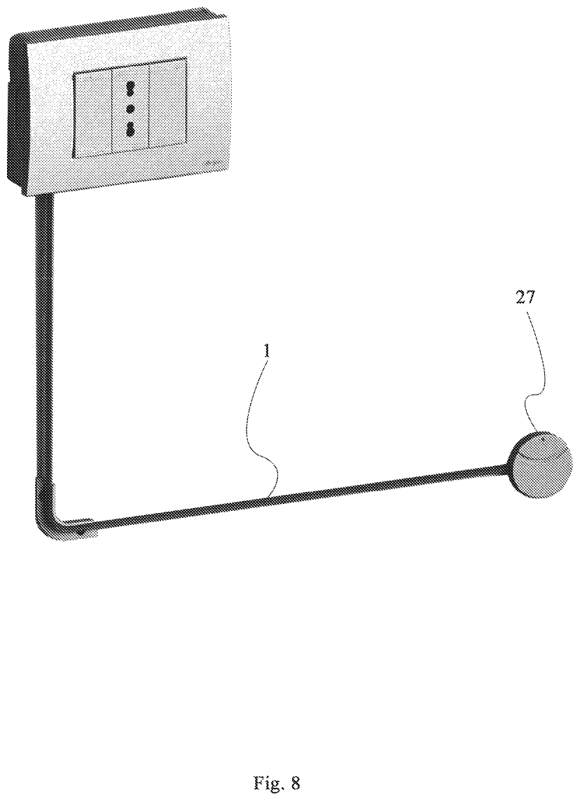

FIG. 8 shows an example of a possible wiring, using the kit of the present invention.

The figure shows a service box, below which a flat frame box 7 is present (not shown) from which an optical cable exits that is directed towards a wall plug 21 covered by the relative cover 27 for allowing the passage of the optical cable in an apartment or an office, such that said cable can reach the socket at its interior. From the edge of the cover 27, as described above, one of the areas with reduced thickness 27a was removed in order to allow the entrance of the optical cable, also with cover 27 positioned. Also present in the figure is a curved element having only one projection along an edge which allows directing the optical cable from the service box to the wall plug 21 according to a compatible curvature angle. The positioning device 1, being made of silicon material, can be manipulated, allowing the obtainment of angled positions, such to be applied according to specific needs without damaging the optical cable at its interior.

FIG. 8 in its entirety also allows showing how the optical cable is always protected and covered, whatever elements of the kit are used.

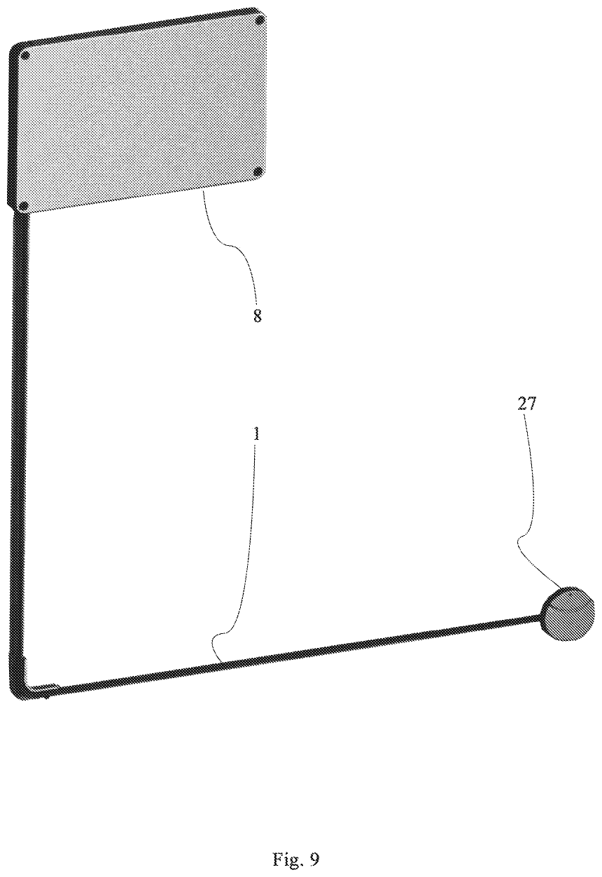

FIG. 9 shows a second possible example of wiring using the kit of the present invention.

In particular, a cover 8 is shown below which (not shown) a flat frame box 7 is present, from which an optical cable exits that is directed towards a wall plug 21 covered by the relative cover 27, for allowing the passage of the optical cable into an apartment or an office such that said cable can reach the socket at its interior. Also in this case, from the edge of the cover 27, one of the areas with reduced thickness 27a has been removed in order to allow the entrance of the optical cable, also with cover 27 positioned. Also present in the figure is a curved element having only one projection along an edge which allows directing the optical cable from the service box to the wall plug 21 according to a curvature angle compatible with the optical cable itself.

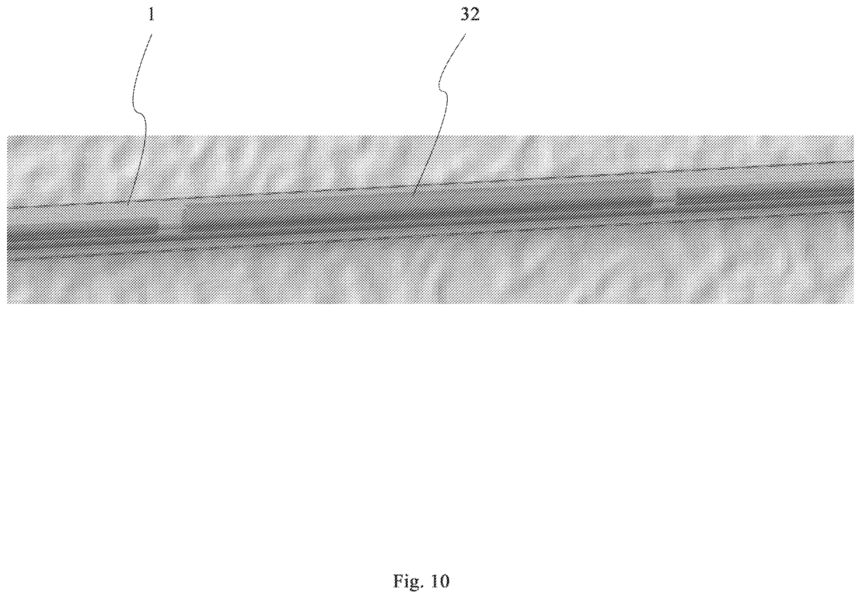

FIG. 10 shows how in case of breakage of an optical cable, this can be repaired by means of a fusion joint whose protection 32 can be housed within the positioning device 1.

Finally, as stated initially, the protection device 1 of the present invention can be used within the rooms of buildings set for office or residential use, also for purposes that different from the wiring of optical cables. Indeed, the positioning device 1 can for example be used for housing the connection cable between an alarm unit and a sensor suitably positioned inside a room, in order to reposition an outlet point or a lighting point within a room.

1-13. (canceled)

14. A positioning device for cables for transporting optical or electrical signals for fixing at least an optical or electrical cable in an interior of a building, said device comprising:
a main body having an internal cavity in which at least one optical or electric cable can be removably housed when said positioning device is positioned on a building material;
a first bottom surface, delimiting the main body at a lower portion thereof and configured to be reversibly fixable to the building material;
second and third surfaces opposite the bottom surface with respect to the cavity and delimiting the main body at an upper portion thereof; said second and third surfaces having an area with a tapered section and corresponding edges arranged in contact in a rest position of the device and movable or deformable so as to be separable in use when an optical or electric cable is inserted into the cavity.

15. The positioning device according to claim 14, wherein the bottom surface comprises an adhesive layer or a double-sided tape to allow the main body to be reversibly fixed to the building material.

16. The positioning device according to claim 14, wherein said positioning device is shaped to house a plurality of cables therein.

17. The positioning device according to claim 14, wherein said device is made of colorless, non-opaque material to facilitate inspection of the optical cables therein.

18. The positioning device according to claim 14, wherein said positioning device is made of flexible material having a degree of hardness between 55 and 65 ShA which allows, when in use, to assume a configuration according to angles compatible with a radius of curvature between 5 mm and 7.5 mm allowed for an optical cable inserted inside it.

19. A method of fixing the positioning device according to claim 14, comprising:
positioning the positioning device in such a way that the bottom surface is in contact with one surface of the building material of interest and the second and third surfaces, having a tapered section area and corresponding edges arranged in contact in a rest position of the device and movable or deformable so as to be separable in use, facing in the opposite direction with respect to the surface of the building material and so that a first end of said positioning device is proximate a first element adapted to house a cable for the transport of optical or electrical signals from which a cable emerges and a second end is proximate a second element adapted to house a cable for the transport of optical or electrical signals; and
inserting the cable coming out of said first element inside the cavity of the positioning device through the tapered section area of the second and third surfaces so that the insertion action causes the separation of the edges to facilitate the insertion action itself.

20. The method according to claim 19, wherein the first and second element adapted to house a cable for carrying optical or electrical signals is one of: a flat frame box, a wall plug, a curved element, a tubular element 31.

21. The method according to claim 19, wherein the first and second element adapted to house a cable for the transport of optical or electrical signals is one of: an apartment socket, a service box, a junction box, an alarm unit, a sensor.

22. An optical cable positioning kit suitable for fixing optical cables in an interior of a building, said kit comprising at least one positioning device according to claim 14, wherein said kit further comprises a flat frame box for optical fiber adapted to receive an incoming optical cable defining a termination point inside the building, and an associated box cover.

23. The kit according to claim 22, further comprising at least one curved element configured to allow wiring of rooms, overcoming the presence of corners, concavities or edges on walls and in accordance with a radius of curvature allowed for an optical cable.

24. The kit according to claim 22, further comprising at least one wall plug configured to allow passage of the optical cable through a wall, and an associated plug cover.

25. The kit according to claim 22, further comprising at least one aid instrument for inserting an optical cable inside at least one component of said kit; said aid instrument having a conical shape and having a hollow body and two openings positioned on two opposite ends according to a longitudinal direction and a groove between a first opening and a second opening such that a cable is readily inserted through the groove and the sliding action of the cable, along the instrument, between the two openings allows the positioning of a cable inside the positioning device, avoiding direct manipulations of the cable.

26. The kit according to claim 22, further comprising a protective joint, housed inside said positioning device adapted to allow the repair of an optical cable in case of breakage, by means of a fusion joint.
